(19) United States
(12) Patent Application Publication
(10) Pub. No.: US 2016/0029846 A1
(43) Pub. Date: Feb. 4, 2016

(54) BEVERAGE CONTAINER CASK

(71) Applicants: Christoph ZICKLER, Vienna (AT); Claire KARLE, Troy, NY (US)

(72) Inventors: Christoph Zickler, Vienna (AT); Claire Karle, Troy, NY (US)

(21) Appl. No.: 14/775,613

(22) PCT Filed: Mar. 14, 2014
(86) PCT No.: PCT/EP2014/055092

§ 371 Date: Sep. 11, 2015

Related U.S. Application Data
(60) Provisional application No. 61/787,494, filed on Mar. 15, 2013.

(51) Int. Cl. A47J 43/27; B65D 21/02; B65D 81/32; B65D 17/00

(52) U.S. Cl. CPC A47J 43/27; B65D 17/165; B65D 21/0231; B65D 81/3211; B65D 2517/0004; B65D 2517/0011

(57) ABSTRACT

The present invention relates to a beverage container containing a top and a bottom lid, wherein both lids possess opening means and to a beverage container cask wherein at least two of said containers are assembled.

The present invention relates to a beverage container comprising a top and a bottom lid, wherein said top and bottom lid possess opening means. At least two containers could be assembled to a container bundle and by opening each other allow the liquids contained in these separate containers to be mixed.

### BACKGROUND OF THE INVENTION

It is possible to completely prepare some beverages during the manufacturing process such that the beverages are ready to consume. However, other beverages, in particular alcoholic beverages (i.e. mixed drinks) exhibit enhanced characteristics if the ingredients are mixed together proximate to when the beverages will be consumed.

For example, maintaining the ingredients separate may prevent the ingredients from interacting with each other and thereby spoiling taste and freshness. Another benefit of mixing the ingredients together proximate to when the beverage is to be consumed is that this process enables the ingredients to be mixed together in proportions that are preferred by the person who will be consuming the beverage.

The ingredients for mixed drinks are generally classified as either alcohol or non-alcohol. These components are typically distributed separately such that the consumer may select one or more alcoholic components for use with one or more non-alcoholic components to prepare the mixed drink.

Preparing an alcoholic or non-alcoholic mixed drink can be a time-consuming, messy and inconvenient process when a number of containers, ingredients and implements are used. It may also be difficult to accurately mix each of the ingredients such that the mixed drink has a flavor that is typically associated with that particular mixed drink. Additionally, liquid may be easily spilled while being poured, which then requires the spilled liquids to be cleaned up.

Various containers, in particular bottles with closures which allow components of a mixed beverage to be decanted and to be stored separately and, if necessary, to be connected to one another, are also already known in the art.

WO2007104409A1 describes a multi-container bundle with at least two can-type individual containers, which are connected by way of their end-side pouring openings, facing one another. They are releasable connected to one another via a coupling element to form a structural unit. At least one of the can-type individual containers is equipped with a lid that can be ripped open completely.

The problem of the present invention is therefore to meet the requirements for the preparation of small amounts of an alcoholic or non-alcoholic mixed beverage. Moreover, the new invention allows consumers to mix drinks on the spot without the need of shaker or separate cup from which to drink. The consumer or the user should also be allowed to obtain as a unit the required metered amount of all of the individual components required for a specific mixed beverage and to process them to form the desired mixed beverage. The solution should be economical, simple and self-explanatory in its application.

### SHORT DESCRIPTION OF THE INVENTION

The solution to these problems consists in a container with opening means on both lids which can easily be connected to one another to form a beverage container cask with two or more individual containers. Developments and/or advantageous variant embodiments of the invention are described herein.

Thus, the present invention relates to a beverage container with a top and a bottom lid, wherein said top and bottom lid possess opening means. Two or more of such individual containers can be connected to one another so as to be releasable via the opening elements and form a beverage container cask and allow the liquids contained therein to be mixed.

### DETAILED DESCRIPTION OF THE INVENTION

The invention relates to a beverage container containing a top and a bottom lid, wherein both lids possess opening means.

An object of the present invention is a container as described above, wherein said container is a can.

A further aspect of the invention is a container as described above, wherein said opening means are female and male threads.

A further aspect of the invention is a cask comprising at least two containers as described above, wherein said at least two containers are connected through the female and male thread.

A further aspect of the invention is a cask as described above, wherein said female and male mating holds the containers in coaxial and facing relationship to each other.

A further aspect of the invention is a cask as described above, wherein said containers are of different or identical size.

A further aspect of the invention is a cask as described above, wherein said containers are standardized size cans.

A further aspect of the invention is a cask as described above, wherein said containers are filled with different beverages.

A further aspect of the invention is a cask as described above, wherein at least one container is filled with an alcoholic beverage.

A further aspect of the invention is a cask as described above, wherein at least two containers are rotated relative to each other to open the mating lids and to allow the beverages to mix.

A further aspect of the invention is a cask as described above, wherein the containers are pre-assembled.

A further aspect of the invention is a cask as described above, wherein the containers are separate and can be assembled by the consumer themselves.

A further aspect of the invention is a cask as described above, wherein the topmost container comprises a container cap.

A further aspect of the invention is a cask as described above, wherein the container cap is connected through a twisting mechanism to the topmost container.

The cask or multiple-container bundle has at least two can-like individual containers which, facing one another at their end-side pouring-out openings, are connected to one another so as to be releasable and form a structural unit. At least one of the can-like individual containers may be equipped with a lid which can be torn open independently to enable pouring or drinking. The multiple-container bundle already contains all of the individual components which are required for a specific mixed beverage and are present in metered form in the individual containers. In this case, mutually incompatible or alcoholic and non-alcoholic components are accommodated in separate individual containers.

Examples of beverages include but are not limited to water, alcohol, non-alcoholic drinks, soft drinks (carbonated drinks), milk, fruit or vegetable juices, coffee and tea. The multi-container bundle allows consumers to choose which liquids they would like to assemble together, e. g. orange juice and vodka or, e. g. strawberry juice and rum or, e. g. orange juice and milk.

Separately sealed containers can be self-attached in the order of one's choice, permitting one to assemble their drink of preference. These containers will be stackable, varying in fluid containing measurements, with the ability to keep fluids from connecting before one chooses to open the drink. With a twisting mechanism the various containers could be attached to one another to create a new drink cask. When twisting it past the point of resistance an opening is created through which the fluids are able to pass and mix together. An additional container cap could be added which will also be connected, for example through a twisting mechanism. This container cap allows consumers and users to open and close the drink and could be screwed off and reused for future drinks. This container will be beneficial to both the alcoholic and non-alcoholic beverage market. The ability to separate the alcoholic liquids from the non-alcoholic liquids in a formation of stacked cans creates an instant mixed drink. This way the alcohol can not disturb the pectin structure of the non-alcoholic liquid and one creates a freshly mixed alcoholic beverage. A similar advantage will apply for any non-alcoholic beverage in which mixing two or more ingredients produce a chemical reaction, thus requiring the ingredients to be mixed at a time proximate to their consumption.

The fact that all the components for a specific mixed beverage are already decanted, metered in the required amount, into the individual containers of the multi-container bundle allows the consumer to procure and to mix together the desired mixed beverage very easily. The various mixed beverages, which are still present in an unmixed form in multiple-container bundles, can each be purchased and stored in their entirety en masse or individually. As required, the corresponding multiple-container bundle is utilized and the mixed beverage ordered is prepared from the components contained therein. The preparation of the mixed beverages is very simple and does not require any specially trained bar staff. The opening end side of the individual containers allows for simple connecting of the individual containers. This simplifies and reduces the cost of producing the multiple-component bundle. If at least one of the individual containers has a lid which can be torn open independently to enable pouring or drinking, this facilitates emptying of the components contained in the individual containers.

An advantageous variant embodiment of the invention provides for the provision of two individual containers embodied as beverage cans. Beverage cans are widely tried and tested and can easily be stored and stacked. On account of their light and gas permeability, they offer good requirements for stability in storage. In terms of their shape too, they are also very well suited to use in a multiple-container bundle.

The beverage container may be fabricated from a variety of materials using the concepts of the invention. Examples of two such suitable materials include but are not limited to metal, preferably aluminum, glass and plastic.

A very expedient variant embodiment of a multiple-container bundle with beverage cans provides for two beverage cans to be oriented axially to each other. The axial arrangement of the beverage cans saves space and facilitates storage of the multiple-container bundle.

All available standardized can formats such as standard cans, slim cans or sleek cans may be produced with a top and a bottom lid, wherein both lids possess opening means to connect at least two cans of the same cross-section dimension (diameter) to a cask.

A first variant of the multiple-container bundle with two beverage cans arranged axially one above the other provides for the two beverage cans to have the same maximum filling volume or a different maximum filling volume. Preferably, the beverage cans are in this case embodied in a similar manner. If account is taken of the fact that mixed beverages are prepared conventionally for drinking glasses having a volume of 200 ml, use may be made of beverage cans which are standardized for the multiple-container bundle and have a maximum filling volume of 150 ml. The use of standardized can sizes reduces the cost of the multiple-container bundle. Ideally, the maximum filling volume of the individual cans is not much greater than the volume of the components contained, so that there is no risk of an undesirable build-up of pressure occurring in the event of accidental heating during transportation or storage of the multiple-container bundle in the individual containers.

In a further variant of the invention, the beverage cans, which are connected to form a multiple-container bundle, can be arranged in an over-pack.

An alternative variant of the multiple-container bundle with two beverage cans arranged axially, one above the other, provides for the two beverage cans to have different maximum filling volumes. For this purpose, the two beverage cans are advantageously embodied so as to be of different size. The larger beverage can has in this case a maximum filling volume of at least 250 ml, while the smaller beverage can has a maximum filling volume of 150 ml. It goes without saying that the beverage cans are never filled completely. Conventionally, the content of the two beverage cans is supplemented to form a mixed beverage having a total volume of approx. 200 ml.

It is advantageous if the larger beverage container is equipped with a lid which can be torn open. Once the lid which can be torn open has been removed, the content of the first beverage container may then be added to the content of the second beverage container. The assembled beverage container can be used as a shaker. The finished mixed beverage can be drunk directly out of the assembled beverage can.

In a further variant embodiment of the multiple-container bundle, both beverage containers having differently large maximum filling volumes are releasable connected to each other. Both beverage containers have lids which can be torn open completely. The connected beverage containers then form the shaker in which the mixed beverage is fully mixed. The fully-mixed mixed beverage can then be drunk directly out of the cask or be poured into a separate drinking glass.

Further advantages and features will emerge from the following description of exemplary embodiments of the invention with reference to the schematic drawings which are not true to scale and in which:

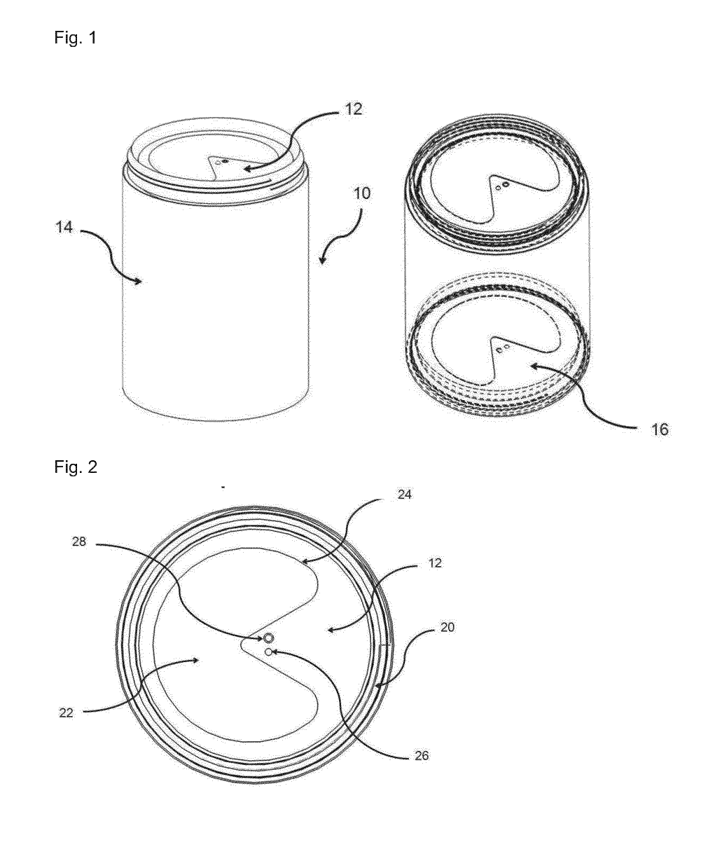

FIG. 1 shows a perspective view of the can

FIG. 2 shows the top view of the can

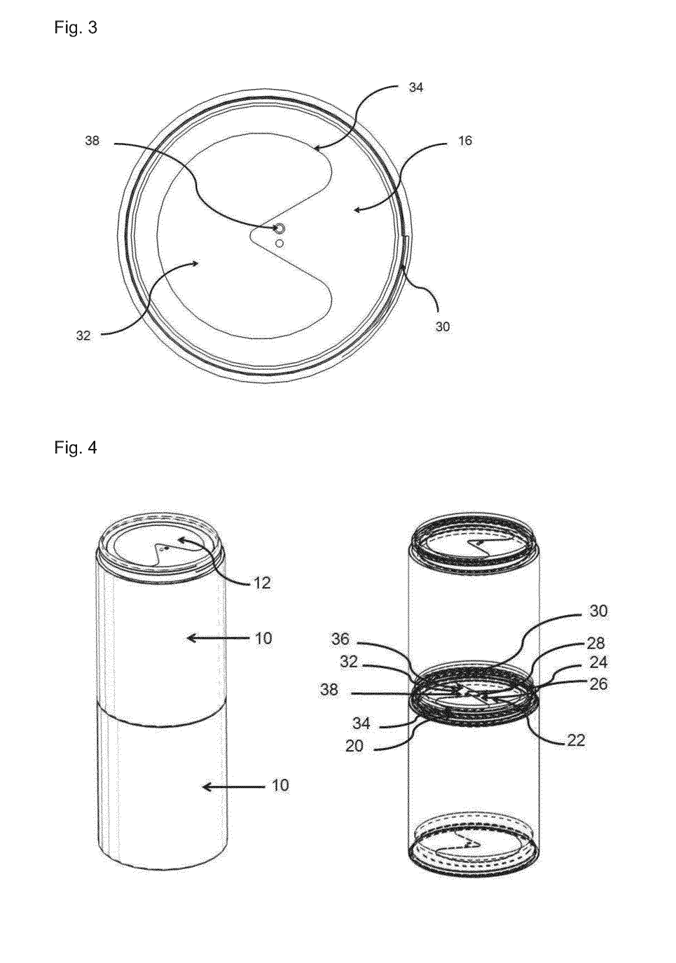

FIG. 3 shows the bottom view of the can

FIG. 4 shows assembled two cans

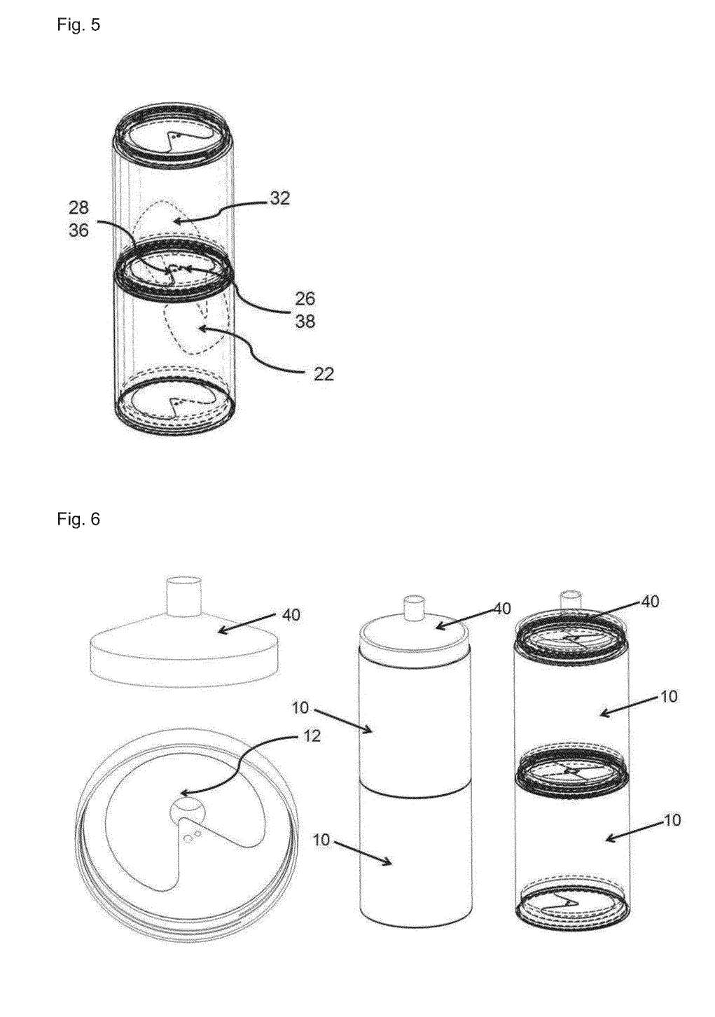

FIG. 5 shows two assembled and twisted cans

FIG. 6 shows a can cap and assembled cans with a can cap

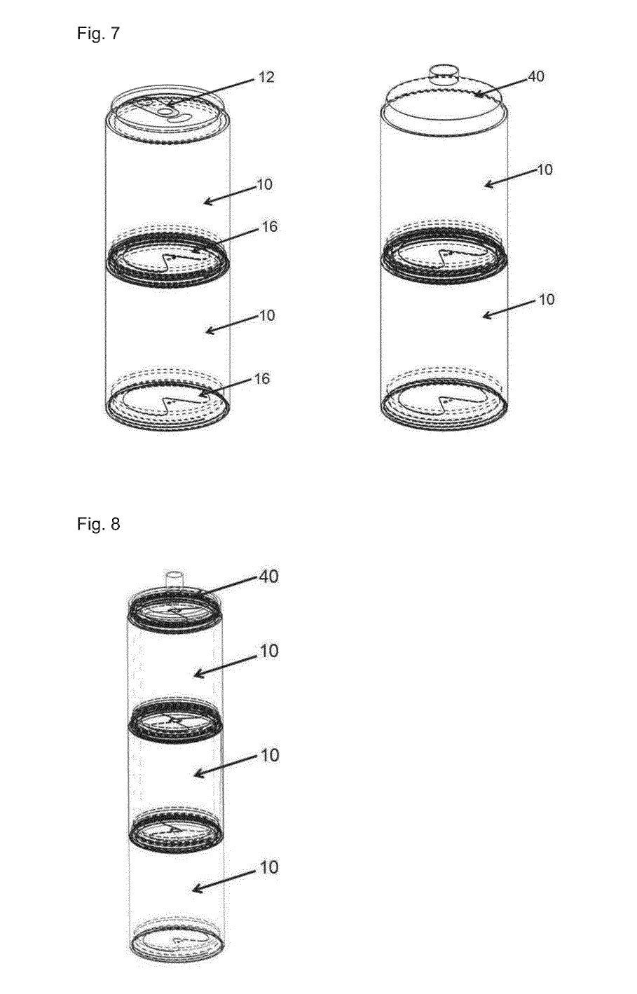

FIG. 7 shows perspective view of pre-half-assembled containers with two different possible lids and with a can cap

FIG. 8 shows how more cans may be connected and a can cap added

FIG. 1, FIG. 2 and FIG. 3 show a beverage can 10 including a top lid 12, a can side 14 and a bottom lid 16. The top lid 12 includes a male thread 20, a can open area 22, a can open line 24, a protrusion opener 26, a recessing stop 28. The bottom lid 16 includes a female thread 30, a can open area 32, a can open line 34, a protrusion opener 36, a recessing stop 38. With the male thread 20 and the female thread 30 two cans are connected and while connecting the two cans allowing the top lid 12 and bottom lid 16 of the two cans to approach each other while rotate relative to each other. And the rotation motion and approaching motion do not need to be in the same step.

The containers open each other through a twisting mechanism. Alternatively the opening between the two cans is created through a piercing force or through a peeling of the scored plate; or any design which, when twisted, opens the opposing container.

When connecting the two containers they are twisted certain degrees to a point of resistance at which point the consumer knows the two cans are sealed airtight. When continuing to twist in the same direction certain degrees past that point of resistance the two containers each break the opposite container's seal which allows the fluid to mix. However, by changing the degrees by which the can twists, or the direction the can twists one does not create a different product.

The beverage can 10 is generally designed, in comparison to other available mixed drink cans containers, to have a low cost, to provide improved convenience, comfort, taste, and variety of flavors, to enhance flexibility to produce. Low cost is because a single can is able to be manufactured using traditional can manufacturing method. Low cost can also be achieved because different drinks can be produced individually instead of having to be produced at one place. This allows producers flexibility of logistics and other benefits hence saving costs.

The beverage container cask is very convenient for the user because the customer only needs to connect the cans, rotate them and shake them. This provides convenience and comfort to mixing drinks by the customers themselves. By not pre-mixing the drink and having the right amount of dose, it provides better taste. There are essentially no limits of how many beverage containers may be connected; this allows great variety of the drinks. Different drinks can be produced separately, giving producers flexibility in time and location, and saving production time.

FIG. 4 and FIG. 5 show a cask before and after the two beverages are mixed. In FIG. 4, when just connecting the two cans, screw the male thread 20 of one can into the female thread 30 of the other can. This brings the openers from the bottom lid 36 and the opener from the top lid 26 closer to the open areas 22 and 32 until they touch. Further screwing the threads, the pressure of the openers tip will tear open the open lines of the top and bottom lids 24 and 34. Continuing the screwing ensures the open lines to be fully open 24, 34 and the openers 26, 28 push the open area away from the lids. Finally, the openers 26, 36 sit in the stops 38, 28, respectively (FIG. 5).

The open areas 22, 32 are pushed away from the lid faces. This enables larger open areas, hence better mixing. However, although the preferred embodiment has only one opener and one open area, the invention allows multiple openers and open areas on the lid. The threads 20, 30 serve as seals during and after the two drinks are mixed. And the two stops 28, 38 enhance the strength of the connection by preventing the two cans from being easily unscrewed, and allow customers to know when the connection is finished. The multiple-container bundle is broadly applicable and may even be used as a shaker and drinking vessel.

FIG. 6 shows a can cap (40) and how the can cap could be attached to two assembled cans (10).

FIG. 7 shows assembled cans, wherein the topmost can (10) has a top lid (12) which is different from the bottom lid (16).

FIG. 8 shows three assembled, not twisted cans (10) with a can cap (40).

1. A beverage container containing a top and a bottom lid, wherein both lids possess opening means.

2. The container according to claim 1, wherein said container is a can.

3. The container according to claim 1, wherein said opening means are female and male threads.

4. A cask comprising at least two containers, each container comprising a top lid and a bottom lid, wherein said at least two containers are connected through mating female and male threads, the bottom lid of a first container facing the top lid of a second container.

5. The cask of claim 4, wherein connecting said female and male threads holds the containers in coaxial and facing relationship to each other.

6. The cask of claim 4, wherein said containers are of different sizes.

7. The cask of claim 4, wherein said containers are standardized size cans.

8. The cask of claim 4, wherein each of said containers is filled with a different beverage.

9. The cask of claim 4, wherein at least one container is filled with an alcoholic beverage.

10. The cask of claim 4, comprising at least two containers that can be rotated relative to each other to open the bottom lid of the first container and the top lid of the second container and thereby allow beverages in the two containers to mix.

11. The cask of claim 4, wherein the containers are pre-assembled.

12. The cask of claim 4, wherein a topmost container comprises a container cap.

13. The cask according to claim 12, wherein the container cap is connected through a twisting mechanism to the topmost container.

14. The cask of claim 4, wherein the containers are identical in size.
